(19) United States
(12) Patent Application Publication
(10) Pub. No.: US 2023/0290946 A1
(43) Pub. Date: Sep. 14, 2023

(54) Vanadium Sulfide/Sulfur Composite Battery Materials

(71) Applicants: Linda Faye NAZAR, Waterloo (CA); Shiqi XU, Waterloo (CA); Chun Yuen KWOK, Scarborough (CA)

(72) Inventors: Linda Faye NAZAR, Waterloo (CA); Shiqi XU, Waterloo (CA); Chun Yuen KWOK, Scarborough (CA)

(21) Appl. No.: 18/006,674

(22) PCT Filed: Jul. 23, 2021
(86) PCT No.: PCT/CA2021/051032

§ 371 Date: Jan. 24, 2023

Related U.S. Application Data
(60) Provisional application No. 63/103,229, filed on Jul. 24, 2020.

(51) Int. Cl. H01M 4/58; H01M 10/0562; H01M 4/62

(52) U.S. Cl. CPC H01M 4/5815; H01M 10/0562; H01M 4/625; H01M 2300/008; H01M 2004/028

(57) ABSTRACT

Cathode materials comprising composites of vanadium sulfide and sulfur are provided along with methods of making same. Solid-state lithium sulfur batteries comprising such cathode materials are also provided.

### CROSS REFERENCE TO PRIOR APPLICATIONS

The present application claims priority under the Paris Convention to US application number 63/103,229, filed on Jul. 24, 2020, the entire contents of which are incorporated herein as if set forth in its entirety.

### TECHNICAL FIELD

This application relates to sulfur/vanadium sulfide composites with utility as cathode materials for secondary batteries and to all solid state batteries utilizing such composites as well as methods of making and using such compositions.

### BACKGROUND

Advanced battery technology requires electrochemistries that go beyond conventional lithium-ion intercalation chemistry to further boost energy density and reduce costs for electric vehicles. Novel chemistries involving conversion reactions have gained considerable attention in recent years as they can invoke a higher number of charge-carriers per mass storage in comparison with the intercalation chemistry utilized by conventional lithium transition metal oxides. In particular, lithium-sulfur (Li—S) chemistry has emerged as a promising candidate owing to its high theoretical specific capacity (1675 mA·h·g⁻¹) and energy density (2500 W·h·kg⁻¹) along with the natural abundance and innocuity of sulfur. However, it is well acknowledged that the commercialization of Li—S technology is still hindered by low active material loading, poor sulfur utilization, poor Coulombic efficiency (CE), and capacity degradation over long-term cycling. These problems primarily originate from the dissolution and redox shuttling of lithium polysulfides in organic solvents (typically a mixture of dimethoxyethane and dioxolane), and the electrically insulating nature of the two redox end members (i.e., S and Li₂S). Much effort has been devoted to the optimization of sulfur cathodes via incorporation of host materials such as nanostructured carbons, transition metal oxides/sulfides, and polymers. Sulfur composites can provide the necessary electronic conductivity and a stable cathode-electrolyte interface and serve as a vehicle for polysulfide entrapment to mitigate sulfur leaching. Some host materials may also participate in reversible redox reactions as active materials. However, the Li—S cells in these studies still rely on polysulfide dissolution-precipitation chemistry, and hence polysulfide shuttling, and/or irreversible build-up of insulating materials that lead to cell death is largely inevitable.

### SUMMARY

Among other things, the present description provides sulfur/vanadium sulfide composites that have high capacity and good electrical conductivity. By replacing the conductive carbon scaffold typical of prior art sulfur cathodes with vanadium sulfide which is both a metallic electron conductor and a lithium ion intercalator, cathodes with high energy density and good cycling characteristics can be produced.

In certain embodiments, substitution of the organic liquid electrolyte for solid-state electrolytes (SSEs) with the provided sulfur/vanadium sulfide composite cathodes leads to further improvement. SSEs that show zero solubility for polysulfides and which can support the solid-solid sulfur/lithium sulfide conversion reaction resolve some of the above-mentioned challenges faced by liquid electrolyte systems. Because both electrode and electrolyte are solid, close high surface-area contact of the two materials is necessary, a significant fraction of SSE in the cathode layer is usually needed to provide an efficient Li+-ion conductive pathway. Thiophosphates are among the most widely used SSE materials in all-solid-state Li—S cells owing to their excellent ductility coupled with good ionic conductivity. However, high surface area carbons are also required in sulfur cathodes to provide the requisite electrical contact for electron transfer to sulfur and the contact of such carbons with the thiophosphate electrolyte can lead to decomposition of the SSE via oxidation during battery charge. This results in poor Coulombic efficiency, especially in the initial cycles until an insulating passivation layer is formed, among other things, the technology described herein provides a solution to this problem by eliminating the need to incorporate conductive carbon in the cathode composite. A

Sulfur hosts that function as alternatives to carbons and encompass both good electronic and ionic conductivity can address these difficulties, such as transition metal sulfides (MxSy, M=V, Ti, Fe, Ni, Mo, etc.). Some of these materials not only display excellent electronic conductivity (comparable to, or better than carbons), but also good Li-ion diffusion properties and chemical stability, and interfacial compatibility with sulfur/thiophosphate materials. Some of these materials can also participate in electrochemical reactions with lithium and hence contribute additional capacity. These principles are beautifully exemplified in a recent report by Passerini et al. (Ulissi, S. I., S. M. Hosseini, A. Varzi, Y. Aihara, S. Passerini, Adv. Energy Mater. 2018, 8, 1801462). of a C/FeS₂/S/SSE composite cathode using 30 wt % active material (S+FeS₂), that was reported to deliver an areal capacity up to 3.5 mA·h·cm⁻² in an all-solid-state Li—S cell. Oxidation of the solid electrolyte (amorphous Li₃PS₄:LiI) on initial charge of the cell led to overcharge and low coulombic efficiency, but the latter improved upon cycling once a passivation layer formed.

Unlike iron sulfide which adopts a pyrite structure, vanadium disulfide exhibits a layered structure where the vanadium is octahedrally coordinated with sulfur atoms to form two-dimensional sheets. The VS₂ sheets are bound together by weak van der Waals interlayer interactions. Within the sheets, electrons are highly delocalized in the overlapping, dangling 3d and S 2pz orbitals of vanadium, leading to the material's metallic properties, and an electron conductivity in the range of 1000 S·cm-1. VS₂ also features a low Li+ migration barrier (0.22 eV) compared to many other redox-active transition metal disulfides. For these reasons, VS2 has been utilized as a cathode material in Li-ion batteries, where it is shown to exhibit a theoretical capacity of 233 mA·h·g⁻¹ within the electrochemical window from 1.4-3.1 V vs. Li/Li+, and to have good structural stability during (de)lithiation.

In one aspect, the present description provides a sulfur/VS₂ composite with utility as a cathode material for high capacity Li—S batteries. In certain embodiments, such composites are combined with a solid electrolyte (e.g., β-Li3PS4), to provide a material featuring multi-channel electronic and ionic conductive networks capable of achieving excellent sulfur utilization at a high active material (S+VS₂) loadings (e.g., 60 wt %, double that of the FeS₂/S battery). The provided solid-state Li—S/VS₂ cells have been demonstrated to deliver a reversible specific capacity of 1444 mA·h·g−1 based on S (or 640 mA·h·g⁻¹ based on S and VS₂) at an active loading of 1.7 mgS+VS2·cm⁻². This translates to a sulfur utilization of ˜85%. A stable areal capacity up to 7.8 mA·h·cm⁻² was also achieved at a very high active material loading of 15.5 mg·cm⁻². To the best of our knowledge, this is the first report of a solid-state Li—S battery which utilizes a metallic transition metal sulfide as a host material that exhibits excellent sulfur utilization, stable cycling, and overall coulombic efficiencies close to 100%.

In another aspect, the present description provides methods of forming sulfur/vanadium sulfide composites.

The present description further provides electrochemical devices. In certain embodiments, the description provides a secondary battery comprising a provided cathode composition. Because of the unique characteristics of the vanadium sulfide sulfur composites, such batteries have properties not previously attainable. In certain embodiments, the vanadium sulfide sulfur composites are utilized as an electroactive material in the cathode of a solid state secondary sulfur battery. In certain embodiments, such batteries are characterized in that they comprise a cathode mixture containing VS₂, sulfur, and a solid electrolyte. In certain embodiments, such batteries are characterized in that the cathode mixture is substantially free of conductive carbon additives.

Thus, in one aspect the present description provides a cathode active material for use in batteries, where the material comprises a composite of vanadium sulfide and sulfur.

In another aspect, the present description provides a solid-state lithium sulfur battery comprising a cathode and an anode, wherein the cathode comprises a composite of vanadium sulfide and sulfur.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosed compositions and methods and are not intended as limiting. For purposes of clarity, not every component may be labeled in every drawing. In the following description, various embodiments are described with reference to the following drawings, in which:

FIG. 1 shows physical characterization of (a-c) VS₂ and (d-f) the S/VS₂ composites. (a-b) SEM and (c) XRD pattern for hexagonal VS₂; (d-e) SEM image and (f) TGA curve for the S/VS₂ composite, yielding a sulfur content of ˜33 wt % at a ramp rate of 5° C.·min⁻¹ under N₂ flow.

FIG. 2 shows investigations of the electrochemical mechanism for the solid-state Li—S/VS₂ battery. (a) CV profile of the S/VS₂/Li₃PS₄|SE|Li/In cell. (b) Electrochemical profile and (c) ex-situ XRD for the same battery at different stages of (dis)charge collected at a current rate of 0.12 mA·cm⁻² (C/10). The Li₃PS₄ reflections in panels D & E are due to the underlying solid electrolyte layer.

FIG. 3 Shows a schematic diagram illustrating the proposed microstructure and discharge mechanism for the solid-state hybrid Li—S/VS₂ battery.

FIG. 4 shows analyses of the interface between Li₃PS₄ (left) and S/VS₂/Li₃PS₄ (right) after 10 cycles at C/10. (a) SEM image of the area; (b-d) EDX elemental mapping of (b) S; (c) P; and (d) V.

FIG. 5 shows the electrochemical performance of the solid-state Li—S/VS₂ battery. (a) Electrochemical profile and (b) long-term cycling of the solid-state cell at an active loading of 1.7 mg·cm⁻². Li/In alloy was utilized as the anode. (c) Long-term cycling of the solid-state Li—S/VS₂ battery (active loading: 1.9 mg·cm⁻²) that utilized lithium metal as the anode. Current density was maintained at 0.27 mA·cm⁻² for the first 100 cycles and then adjusted to 0.13 mA·cm⁻² from the 101st cycle.

FIG. 6 shows Electrochemical profiles of solid-state Li—S batteries that utilized Li/In alloy as the anode at a cathode loading of (a) 7.7 mg·cm⁻² and (b) 15.5 mg·cm⁻². (c) The voltage profiles of cells with varied active material loadings as a function of gravimetric capacity.

FIG. 7 shows a cycling data of the solid-state Li—S/VS₂ battery along with a pictorial representation of the charge and discharge of the S/VS₂ composite cathode.

### DEFINITIONS

In order for the present disclosure to be more readily understood, certain terms are first defined below. Additional definitions for the following terms and other terms are set forth throughout the specification.

In this application, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps. As used in this application, the term “comprise” and variations of the term, such as “comprising” and “comprises,” are not intended to exclude other additives, components, integers, or steps.

About, Approximately: As used herein, the terms “about” and “approximately” are used as equivalents. Unless otherwise stated, the terms “about” and “approximately” may be understood to permit standard variation as would be understood by those of ordinary skill in the art. Where ranges are provided herein, the endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Electroactive Substance: As used herein, the term “electroactive substance” refers to a substance that changes its oxidation state, or partakes in a formation or breaking of chemical bonds, in a charge-transfer step of an electrochemical reaction.

Nanoparticle, Nanostructure, Nanomaterial: As used herein, these terms may be used interchangeably to denote a particle of nanoscale dimensions or a material having nanoscale structures. The nanoparticles can have essentially any shape or configuration, such as a tube, a wire, a laminate, sheets, lattices, a box, a core and shell, or combinations thereof.

Substantially: As used herein, the term “substantially” refers to the qualitative condition of exhibiting total or near-total extent or degree of a characteristic or property of interest.

### DETAILED DESCRIPTION

Generally, the present disclosure is directed to novel materials for use in energy storage devices and related methods for fabricating and using such materials.

Compositions

In one aspect, the present description provides sulfur/vanadium sulfide composites that have been found to have utility as cathode materials in secondary batteries (e.g., Li/S or Na/S batteries). The provided composites feature material properties and nano-structural characteristics that enhance their performance as cathode materials.

The composites described herein comprise vanadium sulfide, which generally comprises a compound of vanadium and sulfur. In certain embodiments, the composite may be manufactured with a particular vanadium sulfide compound but be transformed into a different vanadium sulfide during processing, subsequent manufacturing steps or during utilization in an electrochemical device. In certain embodiments, the provided composites are characterized in that the vanadium sulfide is present in the composite in a form having the empirical formula VₓS₂ₓ (e.g., VS₂, V₂S₄, V₃S₆, etc.). In certain embodiments, the vanadium sulfide in the composite is present as VS₂.

In certain embodiments, the provided composites are characterized in that the vanadium sulfide is present in the composite in the form of nanoscale platelets (nanoplates). In certain embodiments, such vanadium sulfide nanoplates have at least one dimension with a length in the range of 5 to 500 nm. In certain embodiments, on average in the composition, the vanadium sulfide nanoplates have a thickness of less than 500 nm, less than 400 nm, less than 300 nm, less than 250 nm, or less than 200 nm. In certain embodiments, the composite is characterized in that, on average, the vanadium sulfide nanoplates have a thickness less than 180 nm, less than 150 nm, less than 125 nm, or less than 100 nm. In certain embodiments, the composite is characterized in that, on average, the vanadium sulfide nanoplates have a thickness less than 80 nm, less than 70 nm, less than 60 nm, or less than 50 nm, or less than 40 nm. In certain embodiments, the composite is characterized in that, on average, the vanadium sulfide nanoplates have a thickness between about 50 nm and about 200 nm, between about 50 and 150 nm, between about 60 and 140 nm, between about 70 and 130 nm, or between about 80 and 120 nm. In certain embodiments, the composite is characterized in that, on average, the vanadium sulfide nanoplates have a thickness of about 100 nm.

Such vanadium sulfide nanoplates comprise a plurality of layers each layer comprising a substantially planar lattice of vanadium sulfide. In certain embodiments, such layers are separated by approximately 0.25 nm. In certain embodiments, provided composites are characterized in that, on average, the vanadium sulfide nanoplates comprise between about 20 and about 1000 individual vanadium sulfide lattice layers. In certain embodiments, provided composites are characterized in that, on average, the vanadium sulfide nanoplates comprise between about 50 and about 1000 vanadium sulfide layers. In certain embodiments, provided composites are characterized in that, on average, the vanadium sulfide nanoplates comprise between about 100 and about 700 layers, between about 200 and about 600 layers, between about 300 and about 500 layers, or between about 350 and about 450 vanadium sulfide layers. In certain embodiments, provided composites are characterized in that, on average, the vanadium sulfide nanoplates comprise about 400 vanadium sulfide lattice layers.

In certain embodiments, where the composite comprises vanadium sulfide nanoplates. the nanoplates are characterized in that the nanoplates have an average length between about 0.5 and 50 mm. In certain embodiments, where the composite comprises vanadium sulfide nanoplates. the nanoplates are characterized in that the nanoplates have an average length between about 1 and 40 mm, between about 2 and 20 mm, or between about 5 and 10 mm.

In certain embodiments, provided sulfur vanadium sulfide composites are characterized in that the vanadium sulfide is present as nanoplates and the nanoplates are aggregated into particles comprising a plurality of nanoplates. In certain embodiments, such aggregates are substantially spherical in shape. In certain embodiments, provided composites are characterized in that, on average, the aggregates have diameters between about 2 and 200 mm. In certain embodiments, provided composites are characterized in that, on average, the aggregates have diameters between about 5 and 100 mm, between about 5 and 50 mm, between about 10 and 40 mm, or between about 20 and 30 mm.

In addition to vanadium sulfide, the composites provided herein further comprise sulfur. The sulfur may be present as elemental sulfur or as a sulfide of an alkali metal (e.g., Li or Na). Thus, for the purposes of the present description, and unless indicated otherwise, the term “sulfur” as used herein would be understood to mean either elemental sulfur or a sulfide. In certain embodiments, sulfur is present as elemental sulfur and a mass ratio of sulfur to vanadium sulfide is in the range of 1:10 to 10:1. In certain embodiments, the sulfur to vanadium sulfide ratio is between about 5:1 and 1:5, between about 4:1 and 1:4, between about 3:3 and 1:3 or between about 2:1 and 1:2. In certain embodiments, provided composites contain a greater mass of vanadium sulfide than sulfur. In certain embodiments such composites are characterized in that the sulfur to vanadium sulfide ratio is about 1:1.2, about 1:1.5, about 1:2, about 1:2.5, about 1:3, about 1:4, or about 1:5. In certain embodiments, provided composites contain a greater mass of sulfur than vanadium sulfide. In certain embodiments such composites are characterized in that the sulfur to vanadium sulfide ratio is about 1.2:1, about 1.5:1, about 2:1, about 2.5:1, about 3:1, about 4:1, or about 5:1.

In certain embodiments, the provided vanadium sulfide-sulfur composites are characterized in that the sulfur is disposed on the surfaces of vanadium sulfide nanoparticles (e.g., nanoplates or aggregates of such nanoplates). In certain embodiments, the vanadium sulfide nanoparticles are substantially coated in sulfur. In certain embodiments, the vanadium sulfide-sulfur composites are characterized in that the sulfur is melt infused into the vanadium sulfide composition. In certain embodiments, provided vanadium sulfide sulfur composites are characterized in that the vanadium sulfide is present as aggregates of nanoplates where the aggregates feature nanoplates oriented with their faces substantially parallel leaving channels between adjacent plates. In certain embodiments, the channels between adjacent vanadium sulfide nanoplates in the provided composites are at least partially filled with sulfur.

In another aspect, the present description provides compositions suitable for manufacture of solid state batteries. In certain embodiments, such compositions comprise a vanadium sulfide sulfur composite as described above. In certain embodiments, such composites are combined with a solid electrolyte composition. No particular limitations are placed on the identity or structure of such solid electrolytes, and they may comprise inorganic solid electrolytes, polymer solid electrolytes, or combinations of these. Such solid electrolytes may also contain liquids present as plasticizers or gelling agents.

In certain embodiments, the present description provides a mixture comprising a vanadium sulfide sulfur composite and a solid electrolyte. In certain embodiments, the solid electrolyte present in the mixture comprises a sulfide solid electrolyte. The sulfide solid electrolyte is not particularly limited, but examples thereof may include Li₂S—P₂S₅, Li₂S—P₂S₅—LiX (wherein X is a halogen element), Li₂S—P₂S₅—Li₂O, Li₂S—SiS₂, Li₂S—SiS₂—B₂S₃, Li₂S—B₂S₃, Li₂S—P₂S₅—ZₘSₙ (wherein m, n is a positive integer, and Z is Ge, Zn, Ga, or a combination thereof), Li₂S—GeS₂, Li₂S—SiS₂-LisPO₄, and Li₂S—SiS₂-LiₚMO_{q} (wherein p and q are positive integers, and M is P, Si, Ge, B, Al, Ga, In, or a combination thereof). In certain embodiments, a sulfide solid electrolyte comprises sulfur (S), phosphorus (P), lithium (Li), or a combination thereof, as a constituent element. In certain embodiments, a sulfide solid electrolyte comprises all of sulfur (S), phosphorus (P), and lithium (Li). In certain embodiments, a sulfide solid electrolyte comprises Li₂S and P₂S₅. Any of these sulfide solid electrolytes may be used alone or as a combination of two or more thereof.

In certain embodiments, the solid electrolyte present in the cathode mixture may include a sulfide solid electrolyte having a Li₃PS₄ structure. Li₃PS₄ has reasonably good ionic conductivity (0.23 mS·cm⁻¹, Figure S₁). The moderate ductility of Li₃PS₄ enables fabrication of the sulfur cathode composite (S:VS₂:Li₃PS₄) by mixing the Li₃PS₄ powders with the S/VS₂ hybrid active materials via physical blending.

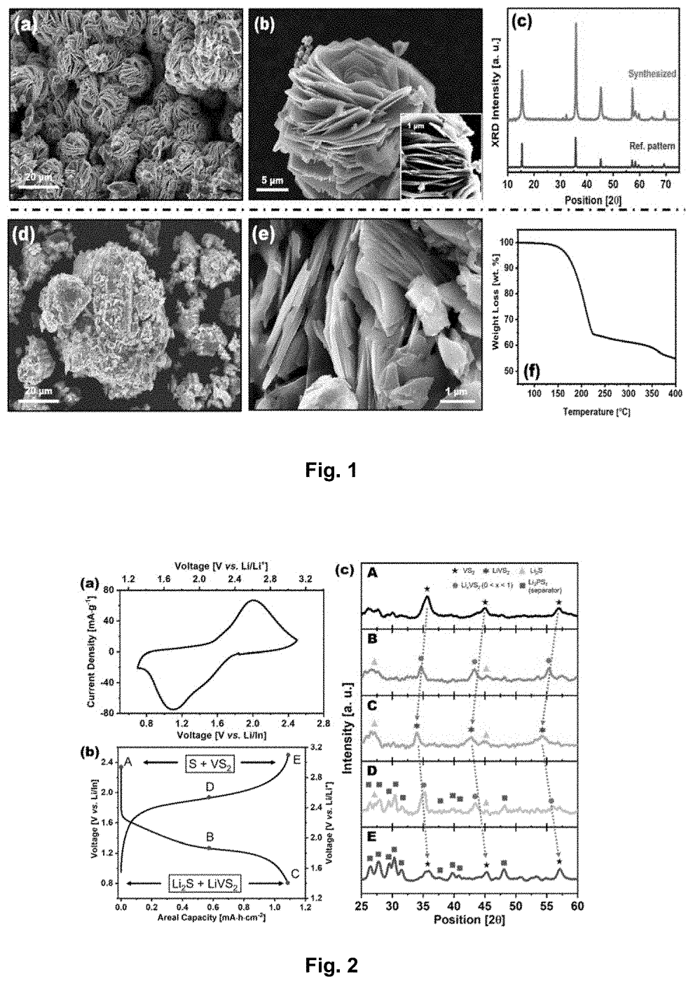

In certain embodiments, provided cathode mixtures are characterized in that the blend of the vanadium sulfide/sulfur composite and solid sulfide electrolyte (e.g., Li₃PS₄) are characterized that direct contact between vanadium sulfide and the solid electrolyte is minimized by virtue of the vanadium sulfide surfaces being substantially coated by a layer of sulfur. This approach preserves the S/VS₂ core-shell architecture (FIG. 1e) while achieving intimate contact between the solid electrolyte and the S/VS₂ composite. SEM and energy dispersive X-ray spectroscopy (EDX) analysis demonstrated that all three components are evenly distributed (FIG. S2). For example, by coating the insulating sulfur layer onto the VS₂ nanoplates prior to mixing them with the solid electrolyte, direct contact between β-Li₃PS₄ and metallic VS₂ is minimized. In certain embodiments, this may be beneficial to limit solid electrolyte oxidation during battery operation.

In certain embodiments, the solid electrolyte present in the cathode mixture may include a halogen-containing sulfide solid electrolyte (i.e., a halide component). In some instances, such halogen-containing electrolytes may have greater ion conductivity (for example, 10⁻³ S/cm or more at 25° C.) compared with a case where no halogen is present and may transport Li ions to the positive electrode active material. The halogen-containing sulfide solid electrolyte can also exhibit an improved effect as a positive electrode electrolyte. In certain embodiments, the halide in the halide containing sulfide electrolyte may be provided in the form of a metal halide salt, for example as lithium halide (LiX), sodium halide NaX, where X may be, for example, chlorine (CI), bromine (Br), or iodine (I)). In certain embodiments, the halide in the halide containing sulfide electrolyte may be provided in the form of an alkyl halide, or the like. Halogen-containing sulfide solid electrolyte compositions may be selected from any of the sulfide solid electrolytes described above. In certain embodiments the sulfide solid electrolytes or the halogen-containing sulfide solid electrolyte are crystalline. In certain embodiments the sulfide solid electrolytes or the halogen-containing sulfide solid electrolyte are amorphous. In certain embodiments the sulfide solid electrolytes or the halogen-containing sulfide solid electrolyte comprise a glass. In certain embodiments the sulfide solid electrolytes or the halogen-containing sulfide solid electrolyte comprise a mixture of a crystalline, amorphous, or glassy phases.

In certain embodiments, the cathode mixtures described herein comprise Li₂S—P₂S₅ mixtures as a sulfide solid electrolyte, the molar ratio of Li₂S to P₂S₅ may be selected from the range of, for example, 50:50 to 90:10. In certain embodiments, the halogen-containing sulfide solid electrolyte comprises amorphous 0.75 Li₂S 0.25 P₂S₅ as a sulfide solid electrolyte material. In certain embodiments, the added halide in the halogen-containing sulfide solid electrolyte may be, but is not limited to, LiX (wherein X is Cl, Br, I, or a combination thereof). When such halide conditions are satisfied, it is possible to improve the charging-discharging capacity of the all-solid-state secondary battery and to improve the conductivity of Li ions in a positive electrode layer made from such mixtures.

In certain embodiments, the cathode mixtures described herein comprise a halogen-containing sulfide solid electrolyte represented by the formula I: aLiX−(100−a)(0.75Li₂S−0.25 P₂S₅), wherein 0<a<50 and X is Cl, Br, or I, or a combination thereof). In certain embodiments, the added halide comprises LiI.

In certain embodiments, the cathode mixtures described herein comprise a halogen-containing sulfide solid electrolyte represented by the formula: 35LiI-65 (0.75Li₂S−0.25 P₂S₅). When the composition of the halogen-containing sulfide solid electrolyte is as described above, it is possible to improve the charging-discharging capacity of the all-solid-state secondary battery made from the provided cathode mixtures and to improve the conductivity of ions in a cathode formed therefrom.

In certain embodiments, the mass ratio of vanadium sulfide/sulfur composite to solid electrolyte in the cathode mixtures described herein ranges from about 1:10 to about 10:1. In certain embodiments, the mass ratio of vanadium sulfide sulfur composite to solid electrolyte in such mixtures ranges from about 5:1 to 1:5, from about 4:1 to 1:4, from about 3:3 to 1:3 or from about 2:1 to 1:2. In certain embodiments, provided mixtures contain a greater mass of solid electrolyte than vanadium sulfide/sulfur composite. In certain embodiments such mixtures are characterized in that the solid electrolyte to vanadium sulfide/sulfur composite ratio is about 1:1.2, about 1:1.5, about 1:2, about 1:2.5, about 1:3, about 1:4, or about 1:5. In certain embodiments, provided composites contain a greater mass of sulfur than vanadium sulfide. In certain embodiments such composites are characterized in that the sulfur to vanadium sulfide ratio is about 1.2:1, about 1.5:1, about 2:1, about 2.5:1, about 3:1, about 4:1, or about 5:1.1:10 to about 10:1.

In certain embodiments, cathode mixtures for solid state batteries are characterized in that they contain an inorganic solid electrolyte which is intimately intermixed with the vanadium sulfide/sulfur composite. In certain embodiments, the solid electrolyte is provided in the mixture as particles. The shape of the solid electrolyte particles included in the provided cathode mixtures are not particularly limited and may include a variety particle shapes such as a spherical, elliptical, plate-like, or fibrous particles. The particle diameter (for example, average particle diameter) of the solid electrolyte is not particularly limited and may be about 0.01 micrometer (μm) to about 30 μm, for example, about 0.1 μm to about 20 μm. Here, the “average particle diameter” refers to a number average diameter of a particle size distribution obtained by scattering or the like, and may be measured by a particle size distribution meter or the like

In certain embodiments, the cathode mixtures described herein are characterized in that they contain little to no conductive carbon additives. This is a unique feature of the inventive mixtures and is possible because of the high electronic conductivity of the vanadium sulfide present in the composite. In certain embodiments, cathode mixtures of the present description are characterized in that they contain less than about 10 wt %, less than about 5 wt %, less than about 2 wt %, less than about 1 wt %, less than about 0.5 wt %, or less than about 0.1 wt % conductive carbon additive. In certain embodiments, the cathode mixtures described herein contain essentially no conductive carbon.

Electrochemistry and the Conversion Mechanism

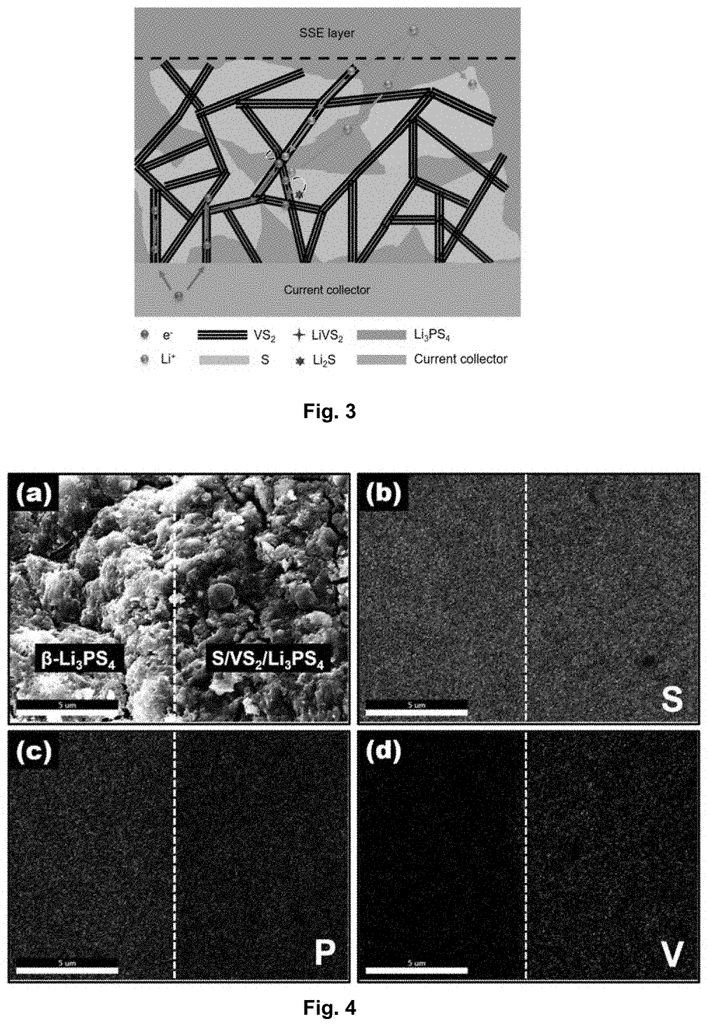

We examined the electrochemistry of the sulfur cathode in a solid-state battery utilizing Li/In alloy (or lithium metal) as anode, and c-Li₃PS₄ as the solid-state electrolyte separator. The well-defined and relatively symmetric cyclic voltammetry (CV) profile indicates good electrochemical reversibility of the S/VS₂ cathode (FIG. 2a). While two redox couples are expected, since both sulfur-conversion (2Li+S↔Li₂S) and Li-intercalation reactions in VS₂ (Li+VS₂↔LiVS₂) potentially take place, the hybrid cathode exhibits only one pair of cathodic (about 1.1 V vs. Li/In) and anodic (about 2.0 V vs. Li/In) peaks at potentials similar to those in other solid-state Li—S cells. We attribute this to the likely similar thermodynamic potentials of the two active materials. To gain insight into the redox mechanism, we conducted ex-situ XRD analysis on the hybrid cathode at different stages of (dis)charge (FIG. 2b-c). Initially (FIG. 2c-A), the pristine cathode composite exhibits three reflections associated with the interlayer reflections of VS₂ while those for the crystalline sulfur are indistinguishable from Li₃PS₄ due to their similar XRD patterns within this region. When the cell was discharged to 0.8 V vs. Li/In (equivalent to 1.4 V vs. Li/Li⁺) (FIG. 2b-C), the VS₂ XRD reflections (located at 36° (011), 46° (102), and 58° (103) in FIG. 2c-A) shift toward much lower angles (FIG. 2c-C). This accounts for approximately a 6% increase in the a and c lattice parameters of VS₂ (SG: P−3m1) due to Li⁺ insertion and formation of isostructural LiVS₂ (JCPSD-98-064-2325). Meanwhile, two new peaks at 27° and 45° in FIG. 2c-C were identified as Li₂S, resulting from sulfur conversion to lithium sulfide. When the cell was charged to 2.5 V vs. Li/In, the phase evolution (A→C in FIG. 2c) of both materials show that their respective pristine counterparts are recovered (FIG. 2c-E). Interestingly, the intermediate stages of the discharge and charge processes (panel B and D in FIG. 2c, respectively) reveal the co-existence of LiₓVS₂ and Li₂S. We conclude that the electrochemical mechanism of the Li—S/VS₂ battery follows a simultaneous conversion/(de)lithiation process, in agreement with the single-peak CV profile in FIG. 2a. Moreover, quantitative analysis of the electrochemical data clearly shows that VS₂ cannot account for the capacity offered by the cell in FIG. 2b. Thus, both sulfur and vanadium disulfide are involved in the redox process. In summary, the solid electrolyte Li₃PS₄ serves as the main ionic conductor to deliver Li+ ions for S/Li₂S redox, and metallic VS₂ functions as the electronic conductor to deliver electrons. However, because lithiated vanadium sulfide (LiₓVS₂) is also a mixed ion/electron conductor and exhibits good Li-ion mobility between the VS₂ atomic layers, it can serve as an additional role as a Li-ion delivery vehicle when it is formed midway through discharge and charge (i.e., LiₓVS₂+S↔Li₂S+VS₂). This concept is illustrated schematically in FIG. 3.

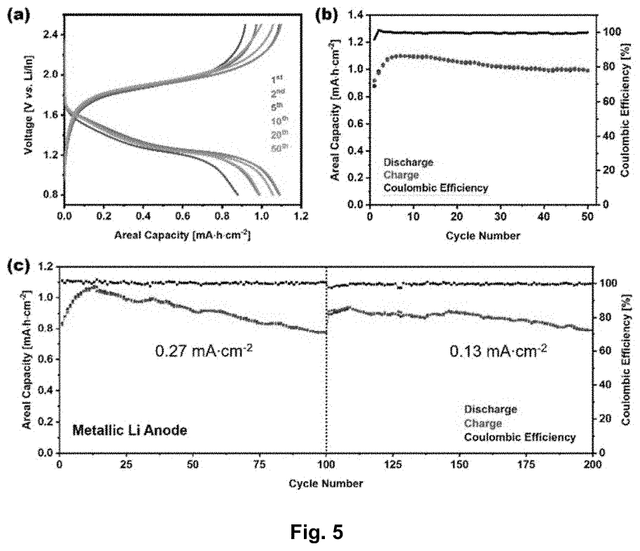

Good interfacial stability of the components in the cathode layer and the thiophosphate in the solid electrolyte layer is another important parameter for the longevity of solid-state batteries. The components in the Li—S/VS₂ cathode and SSE layers do not mix after cycling, as evidenced by the clear boundary between the two layers determined by cross-section EDX analysis after 10 cycles at C/10 (FIG. 4a-d). Sulfur and phosphorus are observed in both the cathode and electrolyte layers owing to the presence of sulfur and Li₃PS₄ (FIG. 4b-c), whereas no vanadium is detected in the electrolyte layer (FIG. 4d), indicating that no elemental diffusion occurs, as expected. In contrast, literature reports show that thiophosphates form an unstable interface with all lithium transition metal oxides on cycling: for example, in a LiCoO₂|Li₂S/P₂S₅ solid-state Li-ion cell, mutual diffusion of Co, P, and S at the cathode-SSE interface and electrochemical oxidation of the thiophosphate on charge result in formation of a high impedance interlayer and subsequent cell degradation.

Long-Term Electrochemical Performance

The long-term electrochemical performance of solid-state Li—S/VS₂ cells was examined by galvanostatic cycling at 25° C. FIG. 5a displays the performance of the S/VS₂ cathode at an areal loading of 1.7 mgS+VS₂·cm⁻² at a current density of 0.12 mA·cm⁻² (equivalent to a rate of C/10). The cathode exhibited an initial discharge capacity of 0.88 mA·h·cm⁻², which increased to 1.1 mA·h·cm⁻² after a few cycles. A high CE of 96% was achieved on the first cycle when the cell was recharged to 2.5 V. Such a high first cycle CE, in contrast to other solid-state Li—S batteries where values as low as 80% have been observed, is attributed to the minimal contact between the metallic VS₂ and the solid electrolyte in the cathode layer, as well as to the electronic conductivity and additional Li-ion delivery pathways provided by VS₂ (FIG. 3). The hybrid cathode reached a specific capacity of 640 mA·h·g(S+VS₂)⁻¹ after several activation cycles, while the CE reached nearly 100% and remained stable hereafter. After subtracting the capacity contribution from VS₂, the specific capacity of sulfur was estimated to be 1444 mA·h·g⁻¹, which corresponds to a high sulfur utilization of about 85%. An areal capacity of about 1 mA·h·cm⁻² was achieved using this configuration, and stable reversible redox behavior was observed (FIG. 5b). We also examined the plausibility of utilizing Li metal as the anode to further boost the energy density at the cell level. The long-term cycling performance of the S/VS₂|SE|Li cell is shown in FIG. 5c. The sulfur cathode delivered an initial discharge capacity of 0.82 mA·h·cm⁻² at an active material loading of 1.9 mg·cm⁻² and exhibited good cycling performance at a current density of 0.27 mA·cm⁻² (about C/5) for the first 100 cycles owing to the formation of a thin passivating layer of Li₂S+Li₃P on Li metal. The current density was halved to 0.13 mA·cm⁻² for the following 100 cycles, where the cell displayed even better cycling performance with a stable capacity of 0.89 mA·h·cm⁻². In contrast, under the exact same cycling conditions, a solid-state Li—S cell fabricated with nanocarbon as the sulfur host exhibited a 30% lower initial capacity of 0.74 mA·h·cm⁻² (compared to 1.1 mA·h·cm⁻² for the VS₂ host), accompanied by a higher overpotential on discharge (Figure S₃). This further supports the finding that VS₂ acts as more than just an electrical conduit for sulfur; it also provides additional capacity in the electrochemical window of sulfur and serves as a lithium ion vehicle. Neither property is provided by carbon materials.

Higher sulfur content in the composite was examined. However, further increasing the sulfur content from 33 wt % to 50 wt % in the hybrid cathode incurs higher cell polarization (0.6 V vs. 0.7 V) and also lower active material utilization (80% vs. 47%) (FIG. 4-S). This can be attributed to the additional insulating sulfur coating on the underlying VS₂ that impedes Li-ion and electron transport. Nonetheless, at the optimized VS₂:S ratio of 2:1, the solid-state Li—S/VS₂ cell demonstrated good rate performance (FIG. 5-S). The cell exhibited a reversible capacity of 0.35 mA·h·cm⁻² at 0.5 mA·cm⁻² (C/2) at room temperature, recovering to 0.85 mA·h·cm⁻² when the current density reverted back to 0.2 mA·cm⁻² (C/5).

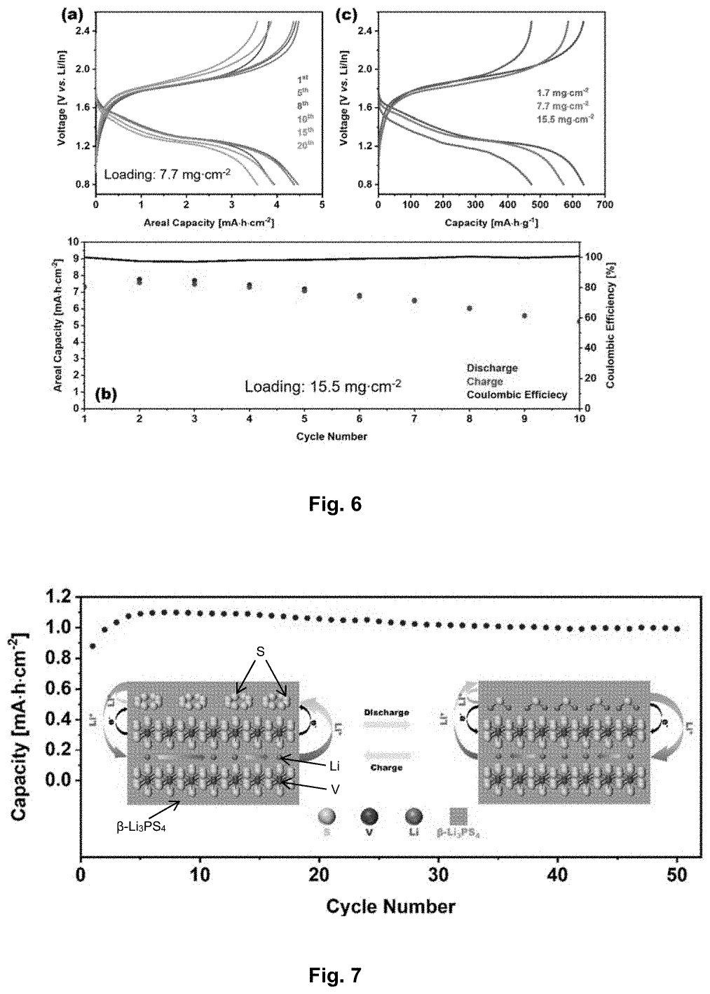

The electrochemical performance of cells with different cathode loadings was also examined. FIG. 6a presents the discharge/charge profile of the S/VS₂ cathode at an intermediate active material loading of 7.7 mg·cm⁻². The hybrid electrode offered an initial discharge capacity of 4 mA·h·cm⁻², which increased to 4.3 mA·h·cm⁻² in the fifth cycle at a current density of 0.12 mA·cm⁻². This corresponds to an active material utilization approaching 80%. Moreover, an ultra-high loading (15.5 mg·cm⁻²) cathode exhibited the highest reversible capacity up to 7.8 mA h·cm⁻² at a current density of 0.12 mA·cm⁻² after the initial activation cycle (FIG. 6b). The cells experienced a slight capacity decay, still delivering a reversible capacity of 5.2 mA·h·cm−2 after 10 cycles. This suggests binders are necessary at the cathode to accommodate the continuous volume expansion/contraction during cycling. Nonetheless, this is amongst the highest areal capacity reported for a solid state Li—S battery to our knowledge. The capacity of each hybrid cathode at a different active material loading is compared in FIG. 6c. There is a gravimetric capacity penalty with an increasing loading owing to the higher polarization in the cell. These can be attributed to the lengthened electronic/ionic pathways in thick electrodes, a common phenomenon in liquid Li—S cells, and can likely be improved by optimizing the cathode microstructure in future studies. The high areal capacity that is achieved is not only one of the highest reported to date in all-solid-state Li—S batteries but is also comparable to some of the recent high sulfur loading studies in liquid Li—S batteries.

### EXAMPLES

The following examples embody certain methods of the present description and demonstrate the fabrication of a nanostructured materials according to certain embodiments herein.

### Example 1: Synthesis of VS₂ and VS₂/S Composites

VS₂ was prepared via a hydrothermal reaction using thioacetamide and ammonium vanadate as precursors. Namely, 2 mmol ammonium metavanadate (NH₄VO₃, 98.5%, AnalaR NORMAPUR™) was dissolved in an aqueous ammonia solution (28 wt %, Sigma-Aldrich), and thioacetamide (ACS grade, Sigma-Aldrich) was then added. The molar ratio between the vanadium and sulfur precursors was approximately 1:5. The homogenous solution was then transferred to a Teflon™-lined autoclave and maintained at 165° C. for 20 hours under static conditions. The black solid thus obtained was rinsed with water and ethanol, and then dried at 90° C. in a vacuum oven for 12 hours. Elemental sulfur was melt-diffused into the obtained VS₂ by heating at 160° C. for 12 h to afford a S/VS₂ composite with a sulfur content of 33 wt %, as determined by thermogravimetric analysis (TGA). Example 2: Characterization of VS₂ and VS₂/S composites

### Example 2: Characterization of VS₂ and VS₂/S Composites

The materials prepared according to Example 1, were characterized by microscopy using a Zeiss Ultra field emission SEM instrument equipped with an EDXS attachment (Oxford). X-ray Diffraction (XRD) data were collected on a PANalytical Empyrean™ instrument outfitted with a PIXcel™ two-dimensional detector operating at 45 kV/40 mA, using Cu-Kα radiation (λ=1.5405 Å). Thermogravimetric, TGA, analyses to determine the sulfur content of the materials, were carried out on a TA Instruments SDT Q500™ at a heating rate of 5° C.·min⁻¹ under a N₂ flow.

Scanning electron microscopy (SEM) of the product of the hydrothermal VS₂ synthesis of (FIG. 1a) reveals that plate-like VS₂ crystallites self-assemble to form flower-like aggregates with diameters of 10-20 μm (FIG. 1a-inset). The lamellar structures in the aggregates are comprised of ˜100 nm thick VS2 nanoplates consisting of stacked VS₂ atomic layers (FIG. 1b). The X-ray diffraction (XRD) pattern in FIG. 1c reveals VS₂ (JCPSD-98-008-6519) is present as the only crystalline component. The successful infiltration of elemental sulfur into the VS₂ nanoplate aggregates via melt-diffusion was evidenced in SEM by the change in the composite (S/VS₂) morphology (FIG. 1d), with respect to the pristine VS₂ nanoplates (FIG. 1b). The rough surface observed on the S/VS₂ lamella and the diminished gaps between the clumped nanoplates (FIG. 1e) suggests the VS₂ layers are (at least partially) covered by sulfur. Thermogravimetric analysis (TGA, FIG. 1f) determined that the elemental sulfur content of the S/VS₂ composite was 33 wt %. Without being bound by theory, it is believed that this sulfur coating of the underlying metallic VS₂-sheet skeleton creates a quasi-core shell morphology that provides the necessary π electronic pathways for electron transfer to sulfur when the materials are pressed together to form a composite cathode. In addition, the small gaps between the individual S/VS₂ plates may create void spaces to accommodate sulfur expansion and maintain structural integrity of the electrode when Li₂S is formed during battery discharge. This composite material, when intimately mixed with the solid electrolyte, enables electronic and ionic avenues that lead to high sulfur utilization during the S↔Li₂S conversion reaction as described below.

### Example 3: Preparation of Cathode Composites Containing SSE

A solid state electrolyte (SSE), β-Li₃PS₄ was prepared by vacuum drying the raw material (Li₃PS₄·3THF, BASF) in a Büchi™ vacuum oven at 150° C. for 48 h. The final cathode composite material was prepared in an Ar-filled glovebox by physically blending the S/VS₂ composite and SSE at a ratio of 6:4. For comparison, a prior art S/C/Li₃PS₄ composite cathode was also prepared using the same method but employing carbon black (Vulcan XC 72R™) as the sulfur host material.

### Example 4: Electrochemical Studies

The electrochemical performance of the solid-state Li—S battery was carried out using custom electrochemical cells assembled in an Ar-filled glovebox. A cylindrical die with an internal diameter of 10 mm was used for pellet preparation. In a typical procedure, approximately 70 mg of the solid electrolyte powder was first pressed between two stainless steel rods. The cathode composite material (S/VS₂/Li₃PS₄ or S/C/Li₃PS₄) was then added to the cathode compartment and further pressed atop the SSE pellet for several minutes. Next, Li foil or Li/In alloy was placed in the anode compartment. Finally, the die was placed in an air-tight stainless-steel casing capable of maintaining constant pressure on the pellet. Screws on the casing were fastened by applying a torque of 9.6 N·m. All electrochemical studies were carried out on a Bio-logic VMP3™ electrochemical station. Cyclic voltammetry and EIS studies were carried out at a scan rate of 0.02 mV·s⁻¹ and an amplitude of 5 mV in the frequency range of 200 mHz to 200 kHz, respectively. Galvanostatic cycling was performed in the potential range of 1.4-3.1 V vs. Li/Li⁺, where the molar ratio of Li:In (maintained at <1) fixes the voltage of the negative Li—In alloy electrode at −0.6 V vs. Li/Li⁺. The theoretical capacity of the S/VS₂ hybrid cathode is 713 mA·h·gVS₂+S−1 at a S:VS₂ weight ratio of 1:2.

It is contemplated that compositions, systems, devices, methods, and processes of the present application encompass variations and adaptations developed using information from the embodiments described in the present disclosure. Adaptation or modification of the methods and processes described in this specification may be performed by those of ordinary skill in the relevant art.

It will be appreciated that use of headers in the present disclosure are provided for the convenience of the reader. The presence and/or placement of a header is not intended to limit the scope of the subject matter described herein. Unless otherwise specified, embodiments located in one section of the application apply throughout the application to other embodiments, both singly and in combination.

Throughout the description, where compositions, compounds, or products are described as having, including, or comprising specific components, or where processes and methods are described as having, including, or comprising specific steps, it is contemplated that, additionally, there are articles, devices, and systems of the present application that consist essentially of, or consist of, the recited components, and that there are processes and methods according to the present application that consist essentially of, or consist of, the recited processing steps.

It should be understood that the order of steps or order for performing certain action is immaterial so long as the described method remains operable. Moreover, two or more steps or actions may be conducted simultaneously.

1: A cathode active material comprising a composite of vanadium sulfide and sulfur.

2: The cathode active material of claim 1, wherein the vanadium sulfide is in the form of platelets.

3: The cathode active material of claim 2, wherein the platelets have an average length of about 0.5 μm to about 50 μm.

4: The cathode active material of claim 2, wherein the platelets have a thickness of less than about 500 nm.

5: The cathode active material of claim 2, wherein the platelets have a thickness of about 50 nm to about 200 nm.

6: The cathode active material of claim 2, wherein the platelets comprise a plurality of layers, wherein each layer comprises a planar lattice of vanadium sulfide.

7: The cathode active material of claim 6, wherein the platelets comprise about 20 to about 1000 layers of vanadium sulfide.

8: The cathode active material of claim 1, wherein the sulfur is present in the composite in the form of elemental sulfur or as a sulfide of an alkali metal.

9: The cathode active material of claim 8, wherein the alkali metal is Li or Na.

10: The cathode active material of claim 8, wherein the sulfur is present in the composite in the form of elemental sulfur and the mass ratio of sulfur to vanadium sulfide is from 1:10 to 10:1.

11: The cathode active material of claim 1, wherein the vanadium sulfide is in form of platelets and the platelets are combined in the form of particles.

12: The cathode active material of claim 11, wherein the particles have an average diameter of about 2 μm to about 200 μm.

13: The cathode active material of claim 11, wherein the sulfur is present as a coating on the vanadium sulfide particles.

14: The cathode active material of claim 1, wherein the vanadium sulfide is in the form of platelets and wherein the platelets are arranged in a substantially parallel manner, whereby channels are formed between opposed platelets.

15: The cathode active material of claim 14, wherein the sulfur is provided within the channels.

16: The cathode active material of claim 1, in combination with a solid electrolyte composition.

17: The cathode active material of claim 16, wherein the solid electrolyte comprises a solid sulfide electrolyte.

18: The cathode active material of claim 17, wherein solid sulfide electrolyte comprises at least one of a sulfur-containing component, a phosphorus-containing component, a lithium-containing component, or any combination thereof.

19: The cathode active material of claim 18, wherein the solid sulfide electrolyte comprises Li₂S and P₂S₅.

20: The cathode active material of claim 18, wherein the solid sulfide electrolyte comprises Li₃PS₄.

21: The cathode active material of claim 18, wherein the solid sulfide electrolyte further comprises a halide component.

22: The cathode active material of claim 21, wherein the halide component is an alkyl halide, a metal halide, a lithium halide, a solid halide, or a combination thereof.

23: (canceled)

24: (canceled)

25: The cathode active material of claim 21, wherein the halide component comprises a chlorine, bromine, or iodine salt.

26: The cathode active material of claim 17, wherein the solid sulfide electrolyte is present in one or more of amorphous, crystalline, or glass phases.

27: The cathode active material of claim 21, wherein the halide is present in one or more of amorphous, crystalline, or glass phases.

28: The cathode active material of claim 19, wherein the molar ratio of Li₂S to P₂S₅ is from about 50:50 to about 90:10.

29: The cathode active material of claim 28, wherein the molar ratio of Li₂S to P₂S₅ is about 75:25.

30: The cathode active material of claim 28, wherein the solid sulfide electrolyte is in amorphous form.

31: The cathode active material of claim 28, wherein the solid sulfide electrolyte further comprises a halide component.

32: The cathode active material of claim 31, wherein the halide component is LiX, wherein X is Cl, Br, or I.

33: The cathode active material of claim 32, wherein the solid sulfide electrolyte is represented by formula (I):
aLiX−(100−a)(0.75Li₂S−0.25P₂S₅)
wherein, 0<a<50 and X is Cl, Br, I, or a combination thereof.

34: The cathode active material of claim 33, wherein the solid electrolyte is in the form of particles.

35: The cathode active material of claim 34, wherein average diameter of the solid electrolyte particles is from about 0.01 μm to about 30 μm.

36: The cathode active material of claim 35, wherein the cathode active material contains less than about 10 wt % of conductive carbon additives.

37: The cathode active material of claim 36, wherein the cathode active material contains less than about 0.1 wt % of conductive carbon additives.

38: The cathode active material of claim 1, wherein the mass ratio of sulfur to vanadium sulfide is about 1:2.

39: The cathode active material of claim 1, wherein the cathode material is formed by combining molten sulfur with the vanadium sulfide.

40: A solid-state lithium sulfur battery comprising a cathode and an anode, wherein the cathode comprises the cathode active material of claim 1.

41: The solid-state lithium sulfur battery of claim 40, wherein the anode comprises metallic lithium.
